(19) United States
(12) Patent Application Publication
(10) Pub. No.: US 2006/0162852 A1
(43) Pub. Date: Jul. 27, 2006

(54) Method, system and device for preparing a winding reel for changing reels in a flying manner, detecting a web of material, and applying a double-sided adhesive tape to a surface

(76) Inventors: Peter Gertsch, Niederscherli (CH); Robert Imhof, Bern (CH)

Correspondence Address: MCGLEW & TUTTLE, PC, P.O. BOX 9227, SCARBOROUGH STATION, SCARBOROUGH, NY, 10510-9227, US

(21) Appl. No.: 10/523,220

(22) PCT Filed: Aug. 5, 2002
(86) PCT No.: PCT/CH03/00529

§ 371 Date: Feb. 1, 2005

(30) Foreign Application Priority Data
Aug. 5, 2002 (DE) 102 35 786.2
Aug. 5, 2002 (DE) 102 35 785.4
Aug. 5, 2002 (DE) 102 35 784.6

(51) Int. Cl. B65H 19/10; B31F 5/00; B32B 37/00

(52) U.S. Cl. 156/157; 156/250; 156/267; 156/505; 156/510

(57) ABSTRACT

A process is provided for preparing a winding roll for a flying roll change by applying an adhesive tape between the beginning of a web and a layer of the winding roll, which layer lies under it. A device is provided for carrying out the process. A device for gripping a part of a material web as well as to a system for gripping a part of a material web is provided as well as a process for gripping a material web. A device is provided for applying a double-sided adhesive tape to a surface as well as to a system with such a device, and a process for applying a double-sided adhesive tape to a surface.

### FIELD OF THE INVENTION

The present invention pertains to a process and a device for preparing a winding roll for flying roll change, especially for preparing rolls of printing web for the flying roll change in a web-fed rotary printing press.

### BACKGROUND OF THE INVENTION

In printing presses, the material to be printed on, e.g., paper, is made available as webs wound on winding rolls. To make printing possible without interruption, a flying change is provided in the press between a winding roll that is running off and a new winding roll. The beginning of the web of the new winding roll is prepared for this with a bonded joint, by which the end of the web of the winding roll running off can be bonded to the new web while the printing press is running. Various methods are known for preparing such a bonded joint.

A process and a device for preparing a paper roll for the flying roll change, in which a section of a paper web is wound off onto an unwinding table, are known from EP 1 041 025 A2. The end area is fixed by generating a vacuum and cut to size. An adhesive tape is arranged at an inner side of the web section cut to size, i.e., on a side that still points inwardly toward the roll in the bonded state, such that part of an outwardly pointing bonding area is bonded with this inner side of the web section and another part of this bonding area remains free for bonding the web of a residual roll. An inwardly pointing bonding area is bonded with the next lower layer of the web on the roll as soon as the processed web section is again brought onto the roll.

Another process and a device for preparing a reserve paper roll for flying roll change are described in EP 0 771 300 B1. The free end of the roll of paper web is pulled off here from the roll and fed to a cross-cutting means, in which the circumference of the web is cut to size by cross-cutting along a cutting groove. Adhesive strips and adhesive labels are subsequently applied to the beginning of the web, which was cut to size, in the vicinity of the cutting edge. A first half of the labels now adheres to the beginning of the web, which was cut to size, and a second half projects beyond the beginning of the web. The beginning of the paper web is finally wound back up on the paper web roll, and the second half of the adhesive labels is pressed by a pressing roller onto the lower layer of the paper web and is bonded to it.

These processes and devices are complicated and require a considerable number of working steps and functional units, because the web must first be unwound over a wide area from the roll and wound up again after the preparation for the roll change. When the end of the web is pressed onto the next lower layer of the winding roll, an active bonding area projecting over the web is often touched. However, this bonding area plays a decisive role during the roll change. The quality of this bonding area may be compromised during the pressing on, and the pressing element may become contaminated. Furthermore, a considerable amount of paper dust is generated during the conventional cutting processes, e.g., due to the use of driven circular knives, and this paper dust both compromises the bonding quality of the bonding area and is harmful for the machines used.

### SUMMARY OF THE INVENTION

The object of the present invention is therefore to reduce and simplify the number of working steps and working units necessary for preparing the winding roll for the flying roll change, to improve the precision and the quality of the bonded joint or to make the bonded joint or the shape of the beginning of the web adaptable to different requirements.

According to one aspect of the present invention, an adhesive tape is placed between the beginning of a web and a subjacent layer of the web of the winding roll in a process for preparing a winding roll for the flying roll change. For this purpose, the beginning of the web is first lifted off from the winding roll by a gripping device. The adhesive tape, which is preferably adhesive on both sides, is then applied by an adhesive tape applicator with a first bonding area onto an area of the web that remains wound up on the jacket surface of the winding roll. The lifted-off beginning of the web is cut to size by a cutting device such that it forms the beginning of a web which is returned onto the winding roll in such a way that it will lie on a second bonding area of the adhesive tape, which said bonding area points outwardly from the jacket surface of the winding roll.

It is not necessary according to the process according to the present invention to unwind a large part of the beginning of the web from the winding roll in order to place an adhesive strip. It is sufficient to lift off the beginning of the web, so that the adhesive tape can be placed under it directly on the outermost web of the winding roll. No separate working area, on which the beginning of the web must be placed and fixed to apply the adhesive tape, is therefore necessary. The beginning of the web, which beginning was cut to size, can be placed on the area of the jacket surface provided with the adhesive tape rapidly and accurately because only a short path must be traveled from the cut-to-size beginning of the web to the bonding area on the winding roll.

Likewise, the adhesive tape or an additional adhesive tape can be placed on the lifted-off part of the web and subsequently bonded with the subjacent part of the web.

A roller, which or the roller jacket of which is in contact with the winding roll, so that it is used as a drive roller for the winding roll and as a depositing roller for the beginning of the web of the winding roll, is preferably used for carrying out the process. In addition, the cut-to-size beginning of the web can again be placed on the area of the jacket surface provided with the adhesive tape by-means of this roller. The roller can be rotated for this purpose in one direction and the winding roll correspondingly in the opposite direction until the beginning of the web comes to lie on the second bonding area and is pressed on by the roller. It is, of course, also possible to rotate only one of the rollers to deposit the beginning of web. The roller is rotated during the deposition of the web only to the extent that the second bonding area will not be touched by it. Contamination of the roller or of the outer bonding area is therefore prevented from occurring, so that the quality of the finished, prepared bonded joint is not compromised for the roll change.

According to another aspect of the present invention, the beginning of the web is fed over a roller after the lifting off from the winding roll during the cutting operation or in the cutting device for cutting the beginning of the web to size, so that the web will lie on the roller. The above-described roller can be used for this purpose. A cutting knife, which is pressed onto the roller with the edge of its cutting blade in a direction that is, e.g., essentially perpendicular to an axis of the roller, is provided in the cutting device. The web, which lies between the roller and the cutting knife, is now severed by the pressing pressure exerted by the knife on the roller.

The shape of the beginning of the web can be preferably varied during the cutting to size in the process of preparing a winding roll. For example, cutting knives of different designs are provided for this purpose in the cutting device for cutting the web to size. Besides a straight knife blade, it is possible to provide, e.g., blades with a zigzag-shaped or rectangular course. As a result, tabs may form at the edge of the beginning of the web, and these tabs are advantageous during the preparation of a winding roll for a properly operated roll changer, because the belts of the roll drive can extend between the tabs. Various other shapes are, of course, also conceivable during the cutting of the edge of the beginning of the web to size.

The beginning of the web of a winding roll can be cut to size accurately in terms of shape and position with the process according to the present invention, so that the beginning of the web formed will fit, e.g., an adhesive tape placed on the jacket surface of the winding roll. Only little paper dust is generated during the separation of the beginning of the winding roll by the punch-like cutting operation described, and slipping of the web is not possible during the cutting operation.

The lifted-off beginning of the web is preferably cut to size at a length that corresponds, when measured from the point of lift-off on the roller to the edge of the web, to such a length that the beginning of the web will cover only a predetermined part of the second outer bonding area after the return onto the winding roll. The residual part of the second bonding area will therefore remain free for bonding to the end of the web of a winding roll running empty. This part may be provided with a masking tape for protecting the part of the bonding area that has remained free until the prepared winding roll is used.

The process according to the present invention is preferably carried out fully automatically.

Various individual features of the working steps of the process according to the present invention may be carried out in various combinations. The procedure proposed shall not define the present invention in a limiting manner.

According to another aspect of the present invention, a device is provided for carrying out the described process for preparing a winding roll. This device has a gripping device for lifting off the beginning of the web of the winding roll, an adhesive tape applicator for placing the adhesive tape on the web of the winding roll, which web is not lifted off, and a cutting device for cutting the beginning of the web to size. The adhesive tape applicator is arranged, e.g., such in the vicinity of the winding roll that the adhesive tape can be placed directly on a web area of the jacket surface of the winding roll that remains wound on the roll and from which the beginning of the web was lifted off.

Along with or as an alternative to the arrangement of the adhesive tape applicator according to the present invention, a cutting device, which has a cutting knife and a drive means for the cutting knife, is provided in the device for preparing a winding roll according to the present invention. The cutting device is arranged in relation to a roller adjoining the winding roll, via which said roller the lifted-off web of the winding roll is deposited, such that the cutting knife with its cutting blade can be moved by the drive means to the roller and can be driven, e.g., essentially in the direction that is perpendicular to the axis of the roller until the blade of the cutting knife strikes the roller. The defined beginning of the web, which is necessary for preparing the winding roll for the roll change, is formed by such a severing of the web in the manner of a punching cut.

According to a preferred embodiment of the device according to the present invention for preparing a winding roll, the arrangements of the adhesive tape applicator, the cutting device and the roller in relation to the winding roll are coordinated such that the cutting site, which forms the beginning of the web, and the web area on which the adhesive tape is placed on the jacket surface of the winding roll are in a predetermined relationship with one another. The beginning of the web is preferably severed such that it will cover only a certain part of the second bonding area when laid down on the second bonding area.

Furthermore, the cutting device is preferably provided with different cutting knives with different blade shapes, which can be selected corresponding to the desired shape of the edge of the beginning of the web. The cutting knives may be provided, e.g., together in a cutter bar of the cutting device and used as desired. It is possible as a result, e.g., to provide tabs at the beginning of the web during the cutting to size such that they will completely cover the adhesive tape in some areas in the circumferential direction. The belts of a belt drive can then be led over this covered area.

In a device for preparing a winding roll, the adhesive tape applicator, the roller and/or the cutting knife may be arranged pivotably. As a result, the adhesive tape can be applied obliquely in relation to the axis of the winding roll and the beginning of the web can be separated fittingly obliquely, as a result of which the winding roll can be prepared for specific requirements during the flying roll change.

The device for preparing a winding roll preferably operates fully automatically.

Other aspects of the present invention pertain to a device, a system and a process for gripping a material web, especially for gripping a partial area, for example, an end section of a material web, which is wound, e.g., on a winding roll, in order to prepare the winding roll, e.g., for a flying roll change at a printing press.

A device for gripping a material web is used, for example, in a printing press to grip and pull off the beginning of the web of a roll and to subject it to further processing as needed.

DE 41 39 586 A1 discloses a process and a device for forming and gripping the beginning of a web of a replacement winding roll, in which the jacket layer of the replacement winding roll is provided with an axially parallel perforation cut, and a pick-up means, which sucks up the jacket layer or is bonded with the jacket layer, is placed at the beginning of the web thus marked. A relative movement is performed between the pick-up means and the replacement winding roll, and the jacket layer is torn open at the perforation cut. Thus, either an additional suction air processing unit or an adhesive feed is necessary, as a result of which the design effort and consequently the costs are increased. If winding rolls of different width are to be gripped, it is relatively complicated to set this device to the corresponding width and to adapt it to the beginning of web to be picked up.

WO 98/52857 discloses a process and a device for gripping a part of an outer layer of a material web of a reserve roll, in which an intake roller which runs together with the paper roll and an intake roller which runs opposite thereto are brought into contact with a part of the outer layer of the material web, parts of the outer layer are subsequently gripped by the intake rollers and pulled in by same between them, so that the outer layer of the material web, which has thus been pulled in, can subsequently be moved forward by the reserve roll along a predetermined path of movement. However, if the coefficient of friction between the topmost layers of the wound-up material web is equal to or greater than the coefficient of friction between the intake rollers and the surface of the material web, the topmost layer of the material web cannot be gripped. Since, e.g., paper dust will settle on the intake rollers in a short time during the operation of such devices because of electrostatic charge, which happens especially during the processing of newsprint, the coefficient of friction between the intake rollers and the surface of the material web will be greatly reduced, so that reliable function of this device is not always guaranteed.

One object of the present invention is to provide a device, a system and a process with which a material web can be gripped and, e.g., pulled off reliably.

The device according to the present invention for gripping a part of a winding roll, e.g. the beginning of the material web, has a first element and a second element, which can be moved in relation to one another in order to jam or fix a part of the material web, for example, a loop of the material web, between them. The first element is designed such that a part of the element or a support surface of the circumference thereof can be placed on the surface of the material web, so that no relative velocity or only a low relative velocity will preferably develop between the part or partial circumference of the first element, which said part or partial circumference is being supported, and the material web. For example, a roll running on the material web may be used. As an alternative, it is also possible to use a nonrotating element, which can be guided over the material web.

The second element is designed such that it can be moved in relation to the material web, i.e., either the material web or the second element or the material web and the element are moved in relation to one another, and the second element can mesh with the material web. “Meshing” is defined in the sense of the present invention as any holding operation with which the second element can grip a part of the material web and carry it with it at least over a certain section. For example, the second element can hook up with the surface of the material web or be brought into connection with the surface of the material web by a preferably sharp edge in order to transmit a movement of the second element in relation to the material web by the meshing with the material web or to fix a moving material web by the meshing at the contact with the second element. The first and second elements can be moved according to the present invention in relation to one another such that the material web gripped by the second element can be held between these elements or, e.g., clamped in the form of a loop of material web after a movement of the first and second elements toward each other. The beginning of a rolled-up material web can thus be gripped and taken off in order to be subsequently provided with a strip of adhesive tape and/or to be cut in order to make possible an automatic roll change.

In general, the device according to the present invention may also be used in other fields, in which the beginning or a section of a material web is to be picked up or pulled off from a winding roll.

The first element may preferably be a roller. In general, any device that has a surface that can be placed on a material web and advantageously does not slide or slip on the material web is suitable for use as the first element, i.e., minimum friction is preferred and synchronism between the first element and the material web is advantageously present, so that, e.g., the first element cannot slip or slide on the material web. For example, a circulating closed web, which is guided around one, two or three rollers and which can be placed on the material web and can be moved together with same, may also be used as the first element. Furthermore, it is possible to use as the first element a holding element, e.g., an edge or an element meshing with the material web, which is placed on the material web and can, e.g., mesh with it in order to thus obtain a defined stop of the material web at the first element, e.g., by the displacement-free fixation of the topmost layer of the material web on a winding roll.

The first and/or second element advantageously has openings and/or interruptions, which can be engaged by the respective other element. For example, the first element, designed as a roller, may have sections with a larger diameter, which can be placed on the material web, and other sections with a smaller diameter, preferably between the sections with the larger diameter, with which the second element can mesh in order to grip or clamp the material web in a subsequent step.

The first element and/or the second element may be preferably driven in order to generate a relative movement between the elements and/or in relation to the material web. A relative movement may be advantageously generated between the beginning of the web, the roller and the first and/or second element.

The first and/or second element may advantageously have at least one elastic element in order to make it possible to meter the pressure desired for meshing with the material web, so that the contact pressure of the first or second element on the material web will be high enough to make possible the reliable meshing or fixing or hooking with the material web, on the one hand, and, on the other hand, to prevent the pressure from becoming so high that the material web would be damaged or cut. For example, an elastic element, e.g., a spring steel, may be arranged at the first or second element or be part of the first and/or second element in order to make it possible to meter the contact pressure of an element with the material web. The dimensioning of the elastic element and/or a pressure or contact angle of the element in relation to the material web to be gripped may be advantageously set such that the force is strong enough to guarantee the reliable flat contact or hooking of the element with the material web without the material web being damaged in the process.

The second element preferably has an edge, for example, a sharp end of a plate or an end of a plate ground in the manner of a knife, which can be placed on the material web in order to mesh with same or to hold it fast or fix it and to hold or clamp the material web or a loop of the material web between the first and second elements after a relative movement between the first and second elements.

A sensor is preferably provided, with which a feature of the material web, e.g., a mark placed on it or the beginning or end of the material web can be detected in order to actuate the device with the use of a suitable control such that a desired part of the material web will be gripped by the cooperation of the first and second elements.

According to another embodiment, the present invention pertains to a system with a material web holding device, a device for gripping a part of the material web, as was described above, and a moving element to move the device toward the material web to grip the material web and/or to move it away from the material web to pick up a gripped section of the material web.

The material web may, e.g., be transported, e.g., unwound from a roll or moved past the device for gripping the material web, which latter device may be, e.g., a stationary device. As an alternative, it is possible to move the device for gripping the material web past a nonmoving or moving material web to grip a part of the material web.

According to another aspect, the present invention pertains to a process for gripping a part of a material web with a first element and a second element, which can be moved in relation to one another, where a part or a circumferential section of the first element can be placed on the material web, so that essentially no or only a very small relative movement will preferably take place between the support surface or the first element and the material web. The second element is moved such that it meshes with the material web and is moved relatively in the direction of the first element in order to thus grip a part of the material web between the first and second elements, so that, e.g., a loop of material web can be clamped between these elements.

The device, the system and the process according to the present invention may be used, in general, in all areas in which the gripping or pulling off of a material web is desired, e.g., in paper-making or processing, in the printing industry, e.g., newspaper printing or label printing, in the production of cigarettes, in the manufacture and/or processing of plastics or films and the coating or finishing of web-shaped materials.

Other aspects of the present invention pertain to a device, a system and a process for applying a double-sided adhesive tape to a surface, especially a paper roll for preparing for a flying roll change at printing presses.

An adhesive tape to be applied, which is adhesive on both sides, is usually covered on one adhesive side with a masking tape, which can be removed from the adhesive tape essentially without damaging the bonding surface. Such a masked double-sided adhesive tape may be wound, e.g., on a roll and is unwound from this roll for application on a surface to be bonded, and there are, in principle, several possibilities of applying such an adhesive tape, which is adhesive on both sides and is masked on one side, to a surface.

If the masking tape is applied to the surface together with the adhesive tape, the masking tape must be subsequently removed from the adhesive tape in an additional, separate operation, which requires an additional working step.

If the adhesive tape is applied to a surface after the removal of the masking tape, an additional device, e.g., a brush roll, as is described in EP 1 041 025 A2, must be present for pressing on the adhesive tape, and residues of the adhesive will remain on the brush roll even in the case of brush rolls made of a special material, so that cleaning and maintenance operations are necessary.

One object of the present invention is to propose a device, a system and a process for applying an adhesive tape that is adhesive on both sides to a surface, which make it possible to apply a freely selectable length of a double-sided adhesive tape and to press it on with the simultaneous removal of the masking tape.

This object is accomplished by the subjects of the independent claims. Advantageous embodiments appear from the subclaims.

The device according to the present invention for applying a double-sided adhesive tape to a surface, e.g., a paper web, has an adhesive tape applicator for feeding an adhesive tape which is adhesive on both sides or is double-sided and which is covered with one or more masking tapes on one side or even on both sides. The masked adhesive tape is fed to a separating device, in which the adhesive tape is separated from the masking tape. The adhesive tape is subsequently fed to a cutting device, which can cut off the adhesive tape according to a preset, freely selectable length. According to the present invention, the adhesive tape is fed to an adhesive tape pressing device, which presses the adhesive tape onto the surface, and the masking tape already pulled off from the adhesive tape is guided such that it will be located between the adhesive tape pressing device and the double-sided adhesive tape in order to completely or at least partly prevent a direct contact between the adhesive tape pressing device and the adhesive tape. A double-sided adhesive tape can thus be applied to a surface of a defined, freely selectable length piece by piece, and the masking tape is pulled off from the adhesive tape simultaneously with the application of the adhesive tape. The device for pressing on the adhesive tape is not contaminated by adhesive, nor is it necessary to pull off the masking tape in an additional working step.

The adhesive tape feeding device is advantageously a roll, on which the double-sided adhesive tape with the masking tape applied to it on one side or on both sides is wound, so that the adhesive tape with the masking tape belonging to it can be pulled off from the roll.

The separating device is preferably a roll, to which the adhesive tape is fed with at least one masking tape lying on it from a first direction, the adhesive tape being pulled off in a second direction and the masking tape or masking tapes being pulled off in a third direction or in other directions from the roll, so that the adhesive tape can be separated from the at least one masking tape. As an alternative, it is also possible to use a stationary element, around which the adhesive tape is led, in which case the direction in which the adhesive tape is pulled off is different from the direction in which a masking tape is pulled off. In general, it is possible to use any element or any device that makes possible the preferably continuous separation of a masking tape from an adhesive tape.

An adhesive tape pressing device may be a roller or a stationary element, with at least one masking tape and the adhesive tape being led around at least one partial area thereof, so that a pressure of the adhesive tape pressing device can be transmitted via the masking tape to the adhesive tape in order to press this to the surface and thus to establish a good bonded connection between the adhesive tape and the surface. A counterelement, e.g., a roller or a stationary element, which is contact with the adhesive tape pressing device, may now be provided to hold or guide the adhesive tape led through between the counterelement and the adhesive tape pressing device.

A movable and/or pivotable element, e.g., a pivotable roll, is preferably provided between the separating device and the pressing device to take up a variable length of a web-like masking tape and to keep the masking tape being fed continuously taut, so that the masking tape can continue to be fed continuously to the adhesive tape pressing device when, e.g., the movement of the adhesive tape, which is preferably being fed continuously, is interrupted to cut the adhesive tape and/or to place a section of adhesive tape, which has been cut off but not yet applied to the surface, on the surface by means of the adhesive tape pressing device. It is thus possible, e.g., to cut the adhesive tape without the masking tape, while the masking tape is being guided continuously and without cutting or interruption, so that the masking tape can be fed by the adhesive tape pressing device continuously and can be wound up continuously by a downstream masking tape pick-up device, e.g., a roll. The movable or pivotable element may be, e.g., a pivotable lever arm, a displaceable element with a mount for a roll or any other element that can be moved to and fro within a predetermined section to vary the overall length of the masking tape web at least in one section of the device.

The cutting device is advantageously arranged between the separating device for separating a masking tape from the adhesive tape and the adhesive tape pressing device, so that the adhesive tape can be cut without cutting through the masking tape originally lying on the adhesive tape, so that the masking tape can be guided continuously.

A masking tape pick-up device, e.g., a roll, which picks up or winds up a masking tape pulled off from the adhesive tape, preferably after the adhesive tape has been pressed on using the masking tape, may be used as a masking tape pick-up device.

According to another aspect, the present invention pertains to a system with an above-described device and with a moving unit to generate a relative movement between the device for applying the double-sided adhesive tape and the surface, so that the double-sided adhesive tape can be placed on the surface continuously or piece by piece.

According to another aspect, the present invention pertains to a process for applying a double-sided adhesive tape to a surface, where a masking tape, which lies on one side or on both sides of the double-sided adhesive tape, is separated from the double-sided adhesive tape and the adhesive tape is severed, i.e., cut off after a predetermined length, and the double-sided adhesive tape is pressed onto the surface by the masking tape that has been fed in again, and the masking tape is again pulled off after the pressing operation.

The adhesive tape can be advantageously applied piece by piece to a surface, for example, an end of a paper roll in order to provide openings, e.g., for drive belts. It is also possible to apply the adhesive tape to various other surfaces.

It is possible, in general, to use partial components of the device or system according to the present invention, e.g., for the semi-automatic preparation or processing of winding rolls, or to install partial components directly in an unwinding device.

Furthermore, it is possible to combine a device according to the present invention together with other devices, e.g., with a paper roll unpacking device.

The present invention will be described below on the basis of an exemplary embodiment, in which winding rolls are processed and bonded fully automatically, so that they can be subsequently introduced into a corresponding unwinding device during a flying roll change. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is a side view showing a device for preparing a roll for a flying roll change in the starting position;

FIG. 2.1 is a sectional view showing an exemplary embodiment of an adhesive tape;

FIG. 2.2 is a sectional view showing the adhesive tape bonded to a surface of the winding roll;

FIG. 2.3 is a sectional view showing the adhesive tape with the adhesive force broken when the flying change has been completed;

FIG. 2.4 is a view showing the paper web cut such that the bonding surface is completely or partially covered in the area of the belts by tabs 68, which are placed at the beginning of the web;

FIG. 3 is a partial sectional view showing the device shown in FIG. 1 during the gripping of a material web;

FIG. 4 is a detail view of a device for gripping the beginning of a web of a winding roll in the starting position;

FIG. 5 is a view of the device shown in FIG. 4 during the gripping of the material web;

FIG. 6 is a view of the device shown in FIG. 4 during the pulling off of the material web;

FIG. 7 is a top view of the rolls shown in FIG. 4 with a gripping plate;

FIG. 8 is a view of the device shown in FIG. 3 after the pulling off of the material web;

FIG. 9 is a view of a device for applying an adhesive tape to a winding roll in the starting position;

FIG. 10 is a view of the device shown in FIG. 9 after the cutting of the adhesive tape;

FIG. 11 is a view of the device shown in FIG. 8 during the cutting of the material web; and

FIG. 12 is a view of the device shown in FIG. 11 during the connection of the beginning of the web to the layer of the winding roll located under it.

### DESCRIPTION OF THE PREFERRED EMBODIMENT

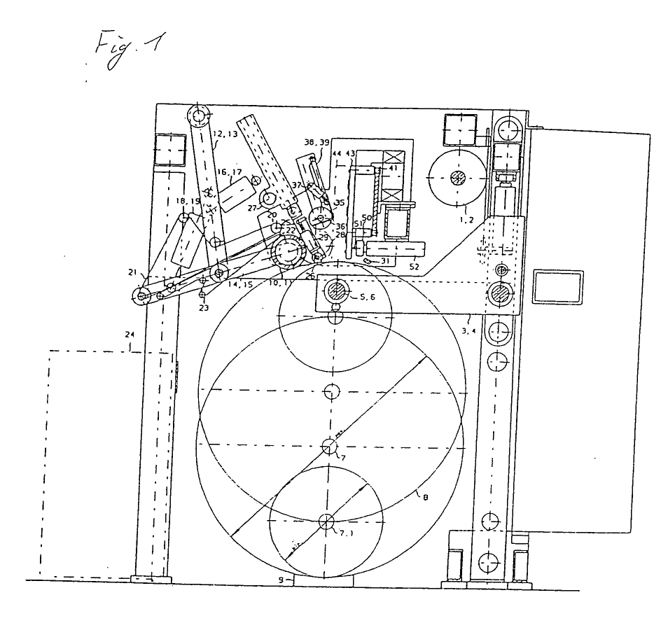

Referring to the drawings in particular, a side view of an exemplary device for preparing a winding roll or paper roll 8 for a flying roll change is shown in FIG. 1. The individual components will be described below.

A roll lifting device, which has cable drums 1, 2, which can be driven with a motor (not shown), is provided to lift a wound-up material web, e.g., a paper roll 8. Furthermore, brackets 3, 4 are provided, and at least one of the said brackets 3, 4 can be displaced in order to thus set the brackets to different widths of paper rolls 8. Freely rotatable carrying lifting lugs 5, 6, which can be introduced into a tube 7 of the paper roll to thus grip the paper roll 8 and lift it by lifting the brackets 3, 4, are provided at the brackets 3, 4. The paper roll 8 is mounted rotatably on the lifting lugs 5, 6.

The paper roll 8 is lifted until it comes into contact with a drive roller 10 for rotating the paper roll 8, a drive motor II for driving the drive roller 10 being provided. Swivel arms 12 through 15, which can be actuated by corresponding working means, e.g., hydraulic cylinders 16 through 19, are used to move the drive roller 10 into the particular necessary working position. A belt system 20 through 23 for removing the cut-off beginning of the paper is provided on the swivel arms 12 through 15.

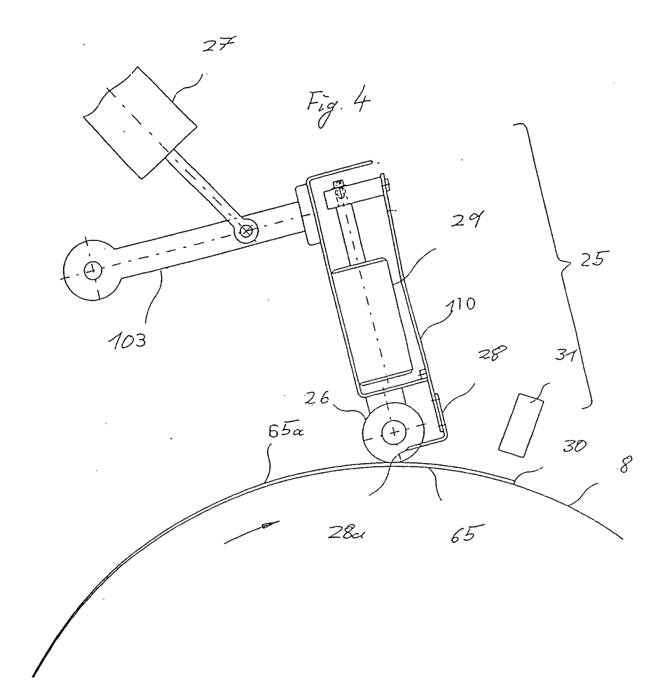

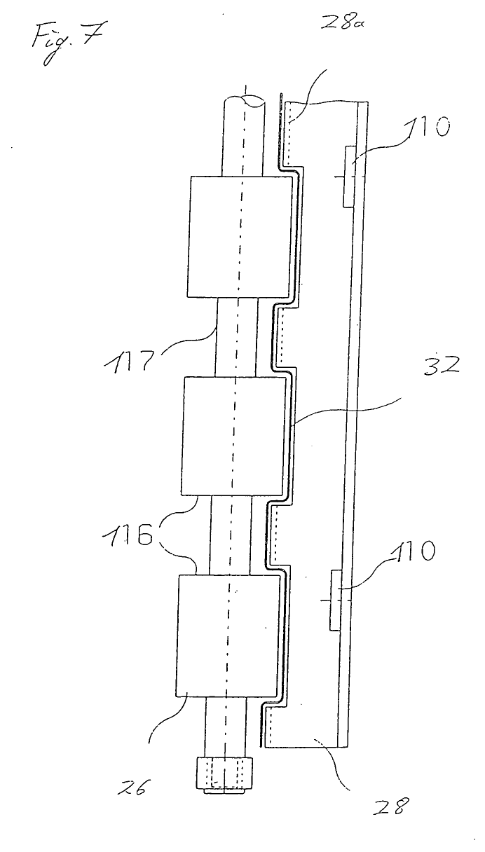

A gripping device 25, which will be described in greater detail below in reference to FIGS. 4 through 7, has rollers 26, which can be lowered with a lifting device 27 onto the jacket surface of the paper roll 8. Furthermore, a gripping plate 28, ground in the manner of a knife, is provided, which can enter between the rollers 26 in the lowered position, as is shown in FIG. 7, and can likewise be lowered onto the paper roll 8 with the working means 29.

Rollers 35 and a finger plate 36, which can be pivoted with working means 37 by means of levers 38, 39 into a position in which they are in contact with the drive roller 10 at one end of the paper roll 8, are provided for positioning the end of the paper web for removal by the belt system 20 through 23.

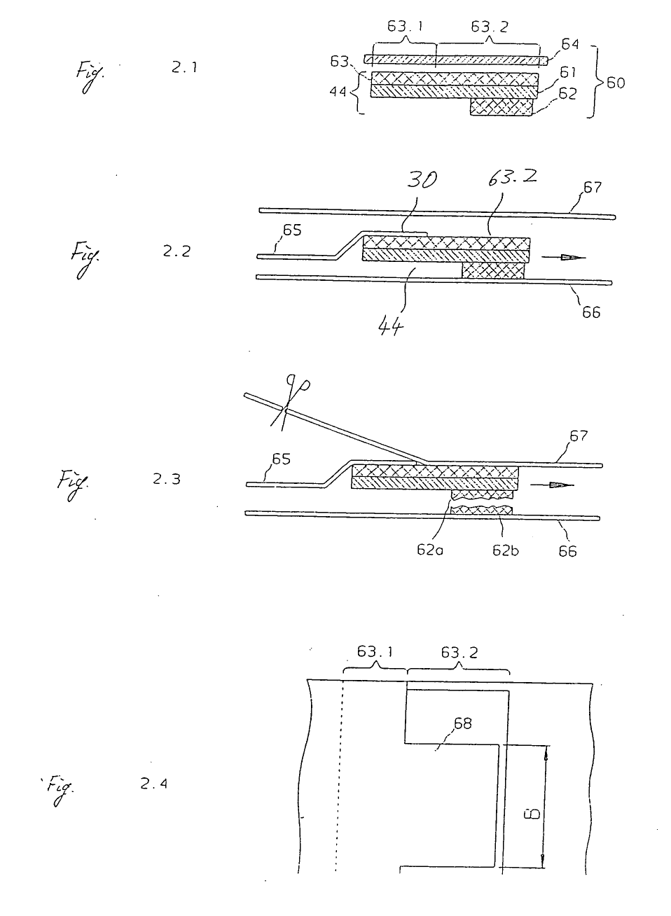

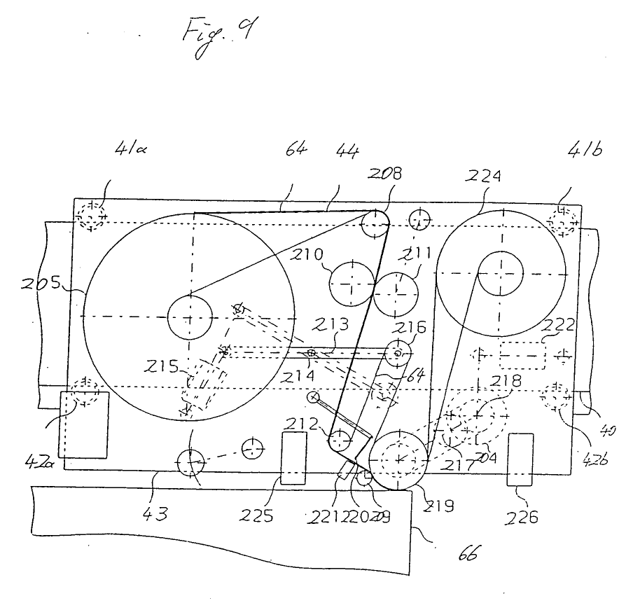

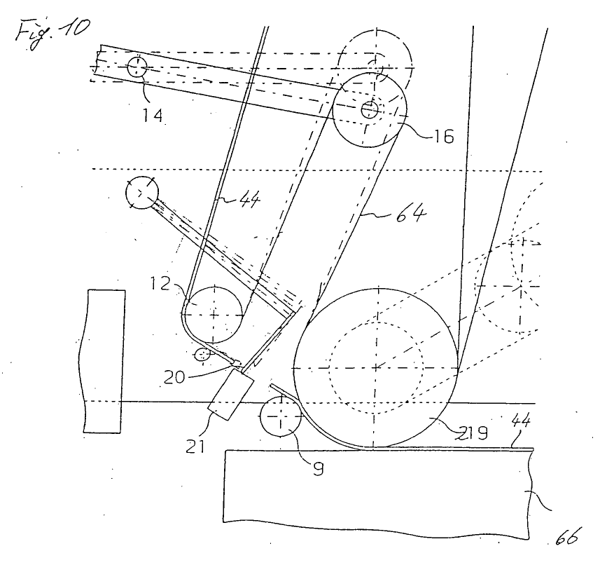

An adhesive tape applicator 45 described in greater detail in FIGS. 9 and 10 has a working carriage 43, which is mounted on a rail 40 with rollers 41, 42, and with which the adhesive tape 44, which is shown as an example in FIG. 2, can be applied and pressed to the paper roll 8 while it moves past the paper roll 8.

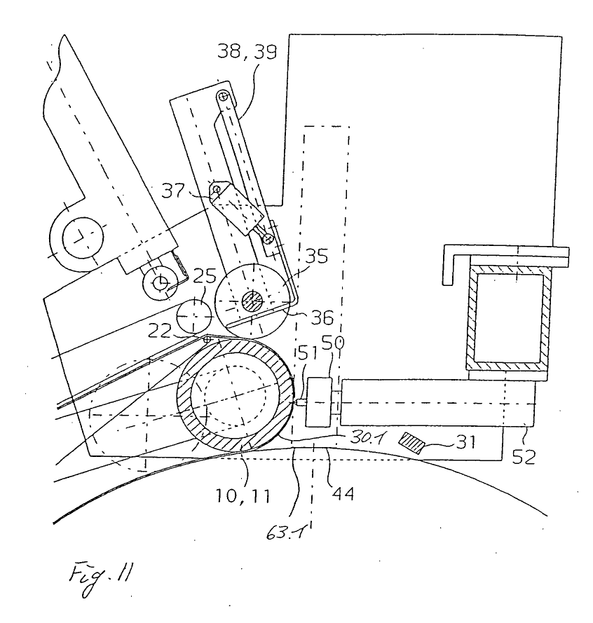

A cutting device with a cutting knife 51 mounted on a cutter bar 50, which cutting knife can be pressed against the roller 10 for cutting the paper web, as will be described in reference to FIG. 11, is provided for cutting off the topmost layer of the winding roll 8 in the correct position.

An adhesive tape 44 that can be used for the device according to the present invention is shown in FIG. 2.1 and has a carrier tape 61 with a first bonding surface 62 arranged thereon, which is made of an adhesive with low adhesive force. Bonding surfaces 63.1 and 63.2 made of an adhesive with a higher adhesive force are provided on the other side of the adhesive tape 44 opposite the first bonding surface 62. A masking tape 64 is used to mask the bonding surfaces 63.1 and 63.2 with high adhesive force. An adhesive with “low” adhesive force and an adhesive with “high” adhesive force are defined as adhesives which can establish a weaker or stronger connection between two materials, i.e., the connection of two elements connected with an adhesive with a low adhesive force can be separated more easily than the connection of two elements which was established by means of an adhesive with high adhesive force. A masking tape 64 used to mask adhesives, which masking tape can be pulled off easily from the corresponding bonding surfaces 63.1 and 63.2, is known in the state of the art and will not be described in greater detail.

To prepare the winding roll, the adhesive tape 44 is bonded to the jacket surface of the winding roll 8 as is shown in FIG. 2.2. The bonding surface 62 connects the next lower layer 66 of the paper roll to the adhesive tape 44, and the bonding surface 63.1 connects the beginning 30.1 of the web to the adhesive tape 44.

If the flying roll change is now initiated, after the velocities of the old and new material webs have been synchronized, the old material web 67 is pressed onto the bonding surface 63.2, and the old web 67 is bonded to the upper, new web 65 via the bonding surface 63.2. The bonded connection with the bonding surface 62 with the lower adhesive force is then broken, so that the winding roll 8 can be unwound, and the old material web 67 is cut off. The flying roll change has been completed (FIG. 2.3).

If the flying roll change is performed in an unwinding device with belt drive, it is advantageous to cut the paper web such that the bonding surface 63.2 is completely or partially covered in the area of the belts by tabs 68, which are placed at the beginning of the web (FIG. 2.4).

As is shown in FIG. 1, a winding roll 8 to be prepared for the flying roll change is brought with a roll cart 9 to the processing device. The width of the roll and the diameter of the roll can be determined by sensors during entry into the processing device.

After they have been automatically set to the necessary paper roll width, the brackets 3 and 4 are lowered to the center of the paper roll 8. The rotatably mounted lugs 5 and 6 are extended and they enter the tube 7 of the winding roll 8. The winding roll 8 is now lifted by rotating the cable drums I and 2 until the upper jacket surface reaches the working position.

The drive roller 10, which is driven by a motor 11, is now lowered onto the paper roll 8 by the levers 12, 13, 14 and 15 by drive means, e.g., pneumatic or hydraulic cylinders, motors or other suitable elements 16, 17, 18 and 19 which generate movement.

The gripping device 25 is now also lowered by the working means 27 until the rollers 26 touch the jacket surface of the winding roll 8.

The drive roller 10, which preferably has a rubber-like jacket surface, is rotated by the motor 11, and drives in turn the winding roll 8 in the clockwise direction by friction.

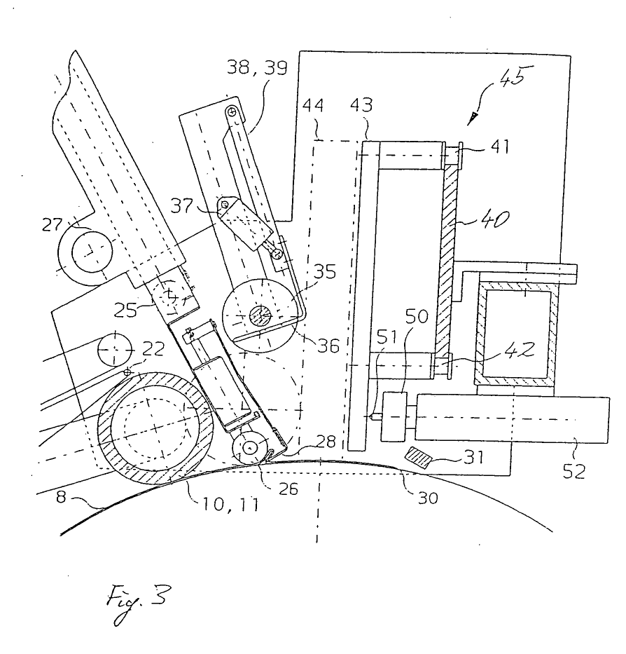

If the beginning 30 of the paper web is reported by a sensor or initiator 31 shown in FIG. 3, the gripping plate 28 of the gripping device 25 is lowered onto the jacket surface of the winding roll 8, as is shown in FIG. 3.

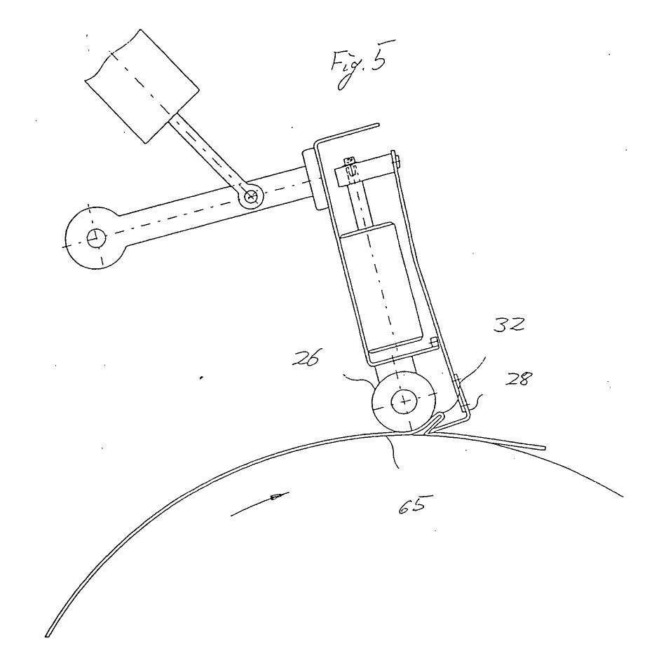

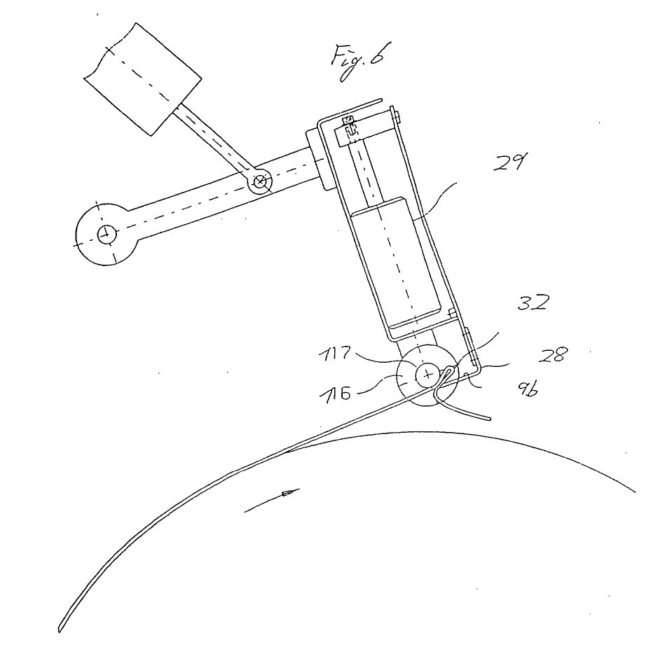

The edge of the gripping plate 28, which is ground in the manner of a knife, hooks up with the topmost paper web of the winding roll 8. A paper loop 32 is formed between the rollers 26 and the gripping plate 28, and, as is shown in FIG. 5, this paper loop is held between the gripping plate 28 and the rollers 26 during the subsequent pulling up of the gripping plate 28. The entire gripping device 25 is lifted by the working means 27, as a result of which the beginning 30 of the paper web is lifted off from the winding roll 8;- FIG. 6.

The operation of gripping the beginning 30 of the paper web of the winding roll 8 will be described in greater detail in reference to FIGS. 4 through 7.

The winding roll 8 shown in FIG. 4 is rotated by the roller 26 and/or a device not shown in the drawing in the direction of the arrow in the clockwise direction. The gripping device 25 is lowered by the working means 27 onto the surface of the winding roll 8 by means of the swivel arm 103. The rollers 26 are now pressed onto the surface 65 of the winding roll 8 and rotate at the same circumferential velocity as this.

If the beginning 30 of the material web is detected by the initiator 3 1, the gripping plate 28, which is fastened to leaf springs 10, is lowered by the lifting device 29 onto the surface of the winding roll 8. The gripping plate 28, which has a knife-like ground edge 28a on the front side, e.g., it has a serrated knife or a knife with a smooth ground edge, is hooked with the topmost layer 65 of the material web. It is advantageous for the pressure with which the gripping plate 28 is pressed onto the material web to be metered as accurately as possible in order to guarantee that this pressure is strong enough for the gripping plate 28 to become reliably hooked up with the topmost layer 65 of the material web, on the one hand, and that, on the other hand, the pressure is not too strong to cut up or damage the material web. The pressure can be selected, e.g., by selecting the manner in which the leaf springs 110 are dimensioned and the angle at which they meet the material web.

As is shown in FIG. 5, the topmost layer 65 of the material web is held back by the gripping plate 28, and a loop 32 of the material web is formed between the rollers 26 lying on the upper material web 65 and the gripping plate 28a after one revolution of the winding roll 8 in the direction of the arrow.

FIG. 6 shows that the gripping plate 28 is now again lifted by the lifting device 29. The loop 32 of material web is now held between the upper part 9b of the gripping plate 28 and the front surfaces 116 of the recesses 117 of the rollers 26, as is shown in FIG. 7.

The gripping device 25 is now lifted off from the surface of the winding roll 8 by the working means 27 by means of the swivel arm 103, and the beginning 30 of the material web is pulled off from the winding roll 8 as a result.

As will be described below, the material web can now be fed to one or more other processes or processing steps, e.g., in order to be cut and provided with an adhesive tape in a station. It is also possible that the material web is unwound by a web pulling device from the winding roll, e.g., to subsequently print on it or to subject it to further processing in another manner. It is, furthermore, possible that the loop 32 of material web is again released by lowering the gripping plate 28 to thus position the beginning 30 of the material web at a desired location.

In addition or as an alternative to the above-described procedure, the gripping device 25 may also be guided along the circumference of the winding roll 8, while the latter is being moved or is stopped to form the loop 32 of material web desired for taking up the beginning 30 of the material web.

FIG. 7 shows a top view of the rollers 26 shown in FIGS. 4 through 6 with the griping plate 28 engaging them. As can be recognized from FIG. 7, the loop 32 of material web is held between the front side 28a of the gripping plate 28, which said front side is ground in the manner of a knife, and the rollers 26 or the front surfaces 116 and recesses 117 of the rollers 26, so that the beginning 30 of the material web can be lifted off from the winding roll 8 as a result.

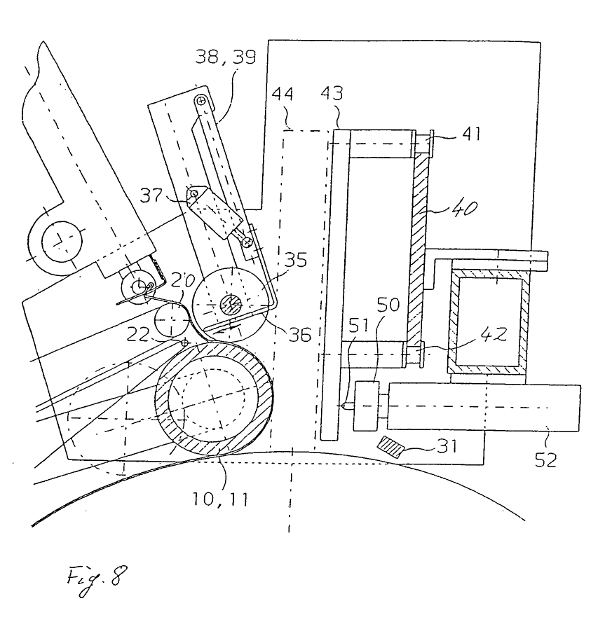

If the upper material web 65 thus being held is lifted by the gripping device 25 to the extent that it was moved past the drive roller 10 and the belt system 20 through 23, as is shown in FIG. 8, the roller 10 can be moved in the direction of the rollers 35 and/or the rollers 35 can be moved toward the roller 10 until the rollers 10 and the rollers 35 touch each other via the beginning 30 of the web located between them. The beginning 30 of the web is thus clamped between the roller 10 and the rollers 35 and it can be pushed by the finger plate 36 into the belt system 20 through 23 after the gripping device 25 has been opened, e.g., by the extension of the gripping plate 28, so that the beginning 30 of the web can be conveyed farther by this belt system 20 through 23.

The roller 10 can now be stopped together with the winding roll 8. The working carriage 43, which is guided by the rollers 41, 42 on the rail 40, can now be moved past the winding roll 8, e.g., in the longitudinal direction. Using corresponding means, the adhesive tape 44 can now be bonded with the bonding surface 62 on the jacket surface of the winding roll 8, and the masking tape 64 can be pulled off at the same time from the adhesive tape 44. Since the paper web to which the adhesive tape 44 is bonded is still wound on the winding roll 8, the web does not need to be held additionally.

FIG. 9 shows a device for applying the adhesive tape 44 with a working carriage 43, which is mounted displaceably on a rail 40 by means of guide rollers 41, 42 and can be displaced by a drive 204.

An unwinding reel 205 with the double-sided adhesive tape 44 and with the masking tape 64 is arranged on the working carriage 43.

As was described above in reference to FIG. 2.1, the adhesive tape 44 is coated with adhesive 63 over its entire width on the side covered by the masking tape 64 and only in an area 62 that accounts, e.g., for about one fourth of the web width on the opposite side.

The guide rollers 208 and 209 as well as the pulling roller 210 may be provided with corresponding openings in the area of the adhesive 62 to prevent adhesive from being deposited on these rollers.

The adhesive tape 44 is led together with the masking tape 64 to the pulling rollers 210 and 211 around the guide roller 208 and to the separating or deflecting roller 212 from the pulling rollers. The two tapes 44 and 64 are separated on the deflecting roller 212.

The masking tape 64 is led around the roller 216, which is located on the lever 213, which, pretensioned with the working means 215 or, e.g., by a spring (not shown), is pivotable around the fulcrum point 214, as is indicated by the broken lines. The masking tape 64 is subsequently led over the pressing roller 219 mounted pivotably around the fulcrum point 218 on the lever 217.

The adhesive tape 44 is led from the deflecting roller 212 through the cutting device 220, 221, and it is likewise led over the pressing roller 219 by means of the guide roller 209, so that the adhesive tape 44 and the masking tape 64 are again united on the pressing roller 219.

When the pressing roller 219 is lowered with the drive means 222 belonging to it onto the object to be bonded, e.g., the lower layer 66 of a paper roll 8, the adhesive tape 44 is now bonded to that object. The masking tape 64 is being wound on the spool 224 during this operation.

The sensors 225 and 226 are used to scan the position and the size of the object 66.

An exemplary work cycle will now be described on the basis of FIG. 10.

The object bonded with the adhesive tape 44, e.g., the layer 65, is brought into the desired position in the area of the working carriage 43. In general, objects of various sizes can also be bonded with adhesive tape 44 or another tape-like material by means of the device described.

The working carriage 43 moves over the object 66 from right to left from its starting position in FIG. 9. The sensors 225 and 226 now recognize the position and the size of the object 66, and a corresponding program is activated.

The working carriage 43 moved to the position at which the beginning of the adhesive tape 44 shall be bonded to the object 66. The pressing roller 219 is now lowered with the adhesive tape 44 onto the object 66 to be bonded.

The working carriage 43 sets again into motion. The unwinding spool 205, the pulling rollers 210, 211 and the pressing roller 219 are preferably driven synchronously with the movement of the carriage, so that the adhesive tape 44 is bonded to the object 66. At the same time, the excess masking tape 64 is wound up on the spool 224.

When the necessary length of the tape 44 to be applied has been reached, the carriage 43, the unwinding spool 205 and the pulling rollers 210 and 211 are stopped. The cutting device 220, 22 1 is actuated. The adhesive tape 44 is cut to the necessary length. The carnage 43 sets again into motion, and the rest of the adhesive tape 44 is applied to the object 66 to be bonded. Since the unwinding spool 205 and the drawing rollers 210 and 211 remain blocked during this operation, the roller 216 is pivoted toward the pressing roller 219 around the fulcrum point 214 in order to enable the masking tape 207 to be pulled off continuously and under tension, as is shown in FIG. I 0.

When the rest of the adhesive tape 44 has now been applied to the object 66 to be bonded, the pressing roller 219 is lifted off from the object 66 with the drive means 222. The pivoting roller 215 is pivoted back into its original position. The masking tape 64 is now unwound from the spool 224.

The adhesive tape 44 is now again fed into the starting position on the roller 219 by rotating the unwinding roller 205 and the pulling rollers 210 and 211. The carriage 43 moves back into its starting position, and a new cycle can begin.

It is equally possible to apply the adhesive tape 44 to the object 66 not only on one piece but also with one or more interruptions and with a spacing selectable in advance. The adhesive tape 44 can be cut to the desired length for this purpose. Another bonding operation may subsequently take place at the desired position.

As an alternative, the applicator may be arranged stationarily, and the object 66 to be bonded may be moved along the device, or the desired relative movement may be obtained by moving the applicator and the object 66.

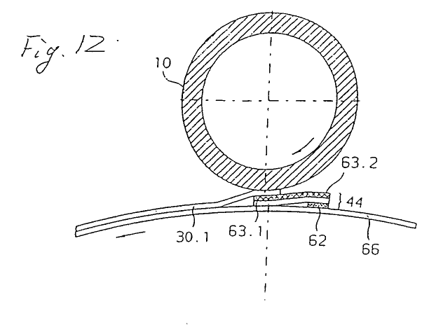

The cut-to-size beginning 30.1 of the paper web can now be prepared by pressing the knife 51, which is arranged on the cutter bar 50, against the roller 10 by means of the working means 52, as is shown in FIG. 11. The paper web is cut off preferably exactly in terms of shape and position in relation to the adhesive tape 44 already bonded on the jacket surface of the paper web, and the new beginning 30.1 of the paper web, cut to size, is subsequently pressed and bonded by the roller 10 onto the bonding surface 63.1 by rotating the roller 10 and/or by rotating the paper roll 8 in the counterclockwise direction by means of the roller 10. The roller 10 is now rotated back to the extent that the bonding surface 63.2 is not touched by it, as is shown in FIG. 12.

The roller 10 advantageously has a surface jacket made of an elastomer.

The knife 51 may be designed such that the new beginning of web can have any desired shape. The cutter bar 50 may also be designed such that it can be equipped with different knives (not shown), which may be used as desired.

After the roller 10 has been swung away from the roller 35, the cut-off rest of the paper web can now be conveyed by the belt system 20-23 into the collection bin 24.

The adhesive tape 44 may be arranged on the jacket surface in parallel to the axis of the winding roll. However, it is also possible to arrange the adhesive tape 44 at an angle obliquely to the axis of the winding roll. The rail 40, the roller 10 and the knife 51 can be pivoted for this in terms of their working positions by the corresponding angle.

The roller 10 can be subsequently lifted off from the winding roll 8, and the winding roll 8 is then lowered onto the transport cart and conveyed farther by same. The device is now ready for processing another winding roll.

While a specific embodiment of the invention has been shown and described in detail to illustrate the application of the principles of the invention, it will be understood that the invention may be embodied otherwise without departing from such principles.

1. A process for preparing a winding roll for a flying roll change by arranging an adhesive tape between the beginning of the web and a web layer of the winding roll, which said web layer lies under it, the process comprising:
lifting the beginning of the web off from the winding roll;
placing the adhesive tape with a first bonding surface on the area of the said web that has remained wound up;
cutting the beginning of the web to size; and
returing the beginning of the web, which has been lifted off and cut to size, onto the sad winding roll, so that a second bonding surface of the adhesive tape comes into contact with the beginning of the web.

2. A process for preparing a winding roll for a flying roll change by arranging a adhesive tape between the said beginning of a web and a layer of the winding roll lying under it, in which:
lifting the beginning of the web off from the winding roll;
placing the adhesive tape on the web;
cutting the beginning of the web to size;
leading the beginning of the web is led over a roller for cutting the beginning of the web to size; and
pressing a sad cutting knife against the roller, so that a cutting blade of the cutting knife is pressed against the circumferential surface of the roller and the web is severed.

3. A process in accordance with claim 1, wherein the beginning of the web is led over a said roller that is in contact with the winding roll.

4. A process in accordance with claim 1, wherein the shape of the edge of the beginning of the web is variable by using cutting knives of different designs to cut the web to size.

5. A process in accordance with claim 1, wherein the lifted-off beginning of the web is cut to size over such a length, measured from the point of lift-off to the edge of the web, that the beginning of the web covers only a predetermined part of the second bonding surface after returning to the winding roll.

6. A process in accordance with claim 1, wherein the beginning of the web is wound off by rotating the said roller and/or the winding roll onto the second bonding surface without the roller touching the bonding surface.

7. A process in accordance with claim 1, wherein the steps of lifting, placing cutting and returning are carried out fully automatically.

8. A device for lifting the beginning of a web off from a winding roll, placing adhesive tape on the web and cutting the beginning of the web to size the device comprising:
a gripping device for lifting off the beginning of a web of the winding roll;
a an adhesive tape applicator for placing an adhesive tape on the web of the winding roll, the adhesive tape applicator being arranged such that the adhesive tape can be placed on an area of the web on the jacket surface of the winding roll, which said web area has remained wound up, and from which the beginning of the web was lifted off.

9. A device in accordance with claim 8 further comprising a cutting device for cutting the beginning of the web to size, wherein the sad cutting device has a said cutting knife and a drive means and is arranged in relation to a roller, which adjoins the winding roll and via which the lifted-off web of the winding roll can be deposited, such that the cutting knife can be driven in the direction of the roller.

10. A device in accordance with claim 9, wherein the arrangements of the adhesive tape applicator, the cutting device and the roller in relation to the winding roll are coordinated with one another such that the cutting site of the beginning of the web and the web area with the said adhesive tape on the sad winding roll are in a predetermined relationship to each other.

11. A device in accordance with claim 9, wherein the adhesive tape applicator, the roller and/or the cutting knife are pivotable.

12. A device in accordance with claim 9, wherein the said cutting knife of the cutting device is replaceable.

13. A device in accordance with claim 9, wherein a plurality of said cutting knives with different blades shapes are provided in the cutting device.

14. A device in accordance with claim 8, wherein the gripping device and the adhesive tape applicator operate fully automatically.

15. A device for gripping a part of a material web, the device comprising:
a first element; and
a second element, which can be moved in relation to the first element, wherein a part of the first element can be placed on the material web and the second element can mesh with the material web, so that the material web can be gripped between the first element and the second element by a relative movement between the first element and the second element.

16. A device in accordance with claim 15, wherein the sad material web is wound up on a winding roll.

17. A device in accordance with claim 15, wherein the first element is a rotatable roller element.

18. A device in accordance with claim 15, wherein the first element is a gripping element, which can be placed on the material web.

19. A device in accordance with claim 15, wherein the first element and/or the second element have at least one opening to mesh with each other.

20. A device in accordance with claim 15, wherein the first element and/or the second element can be driven, so that a relative movement can be generated between the s first and second elements and/or a relative movement can be generated between the first element and the material web or between the second element and the material web.

21. A device in accordance with claim 15, wherein the first element and/or the second element have an elastic element (110) to meter the contact or pressing pressure on the material web.

22. A device in accordance with claim 15, wherein the second element has an edge, which can mesh with the material web.

23. A device in accordance with claim 15, further comprising: a said sensor for detecting a feature of the material web.

24. A device in accordance with claim 23, further comprising: a control controlling the relative movement between the first element and/or the second element and/or the material web using the signal detected by the sensor.

25. A system for gripping a part of a material web, the system comprising
a material web holding device;
a device for gripping the material web with a first element and a second element, which can be moved in relation to the first element, wherein a part of the first element can be placed on the material web and the second element can mesh with the material web, so that the material web can be gripped between the first element and the second element by a relative movement between the first element and the second element; and
a moving element to move the device for gripping the material web in relation to the material web holding device.

26. A system in accordance with claim 25, wherein the material holding device is moved in relation to the device for gripping the material web.

27. A system in accordance with claim 25, wherein the device for gripping the material web is moved in relation to the material web holding device.

28. A process for gripping a material web, the process comprising the steps of:
placing a first element on the material web;
bringing a second element into meshing with the material web; and
holding the material web between the first element and the second element by a relative movement between the first element and the second element.

29. A process in accordance with claim 28, wherein the gripped material web is picked up by a movement of the first and second elements holding the material web.

30. A device for placing a double-sided adhesive tape on a surface, the device comprising:
an adhesive tape feeding device for feeding the double-sided adhesive tape masked with at least one masking tape,
a separating device for separating the double-sided adhesive tape from the at least one said masking tape,
a cutting device for cutting the double-sided adhesive tape; and
an adhesive tape pressing device for bringing together and/or pressing on the double-sided adhesive tape, wherein the at least one masking tape is led between the adhesive tape pressing device and the double-sided adhesive tape which is to be pressed on.

31. A device in accordance with claim 30, wherein the adhesive tape feeding device is a roller.

32. A device in accordance with claim 30, wherein the separating device for separating the double-sided adhesive tape from the at least one masking tape is a roller or a stationary element.

33. A device in accordance with claim 30, wherein the adhesive tape pressing device is a roller or a stationary element.

34. A device in accordance with claim 30, wherein a movable or pivotable element is provided to pick up a variable length of the masking tape.

35. A device in accordance with claim 30, wherein the cutting device is arranged between the separating device and the adhesive tape pressing device.

36. A device in accordance with claim 30, further comprising: a masking tape pick-up device provided for taking up the masking tape.

37. A system with a device in accordance with claim 30, further comprising: a moving unit for generating a relative movement between the device for applying the double-sided adhesive tape and the said surface.

38. A process for placing a double-sided adhesive tape on a sad surface, the process comprising:
pulling a masking tape covering the double-sided adhesive tape is off from the double-sided adhesive tape;
severing the adhesive tape after a predetermined length; and
pressing the double-sided adhesive tape onto the surface by a pressure applied on the masking tape which has been returned.

39. A process in accordance with claim 38, wherein the double-sided adhesive tape is applied to the surface piece by piece.

40. A process in accordance with claim 2, wherein the beginning of the web is led over a roller that is in contact with the winding roll.

41. A process in accordance with claim 2, wherein the shape of the edge of the beginning of the web is variable by using cutting knives of different designs to cut the web to size.

42. A process in accordance with claim 2, wherein the lifted-off beginning of the web is cut to size over such a length, measured from the point of lift-off to the edge of the web, that the beginning of the web covers only a predetermined part of the second bonding surface after returning to the winding roll.

43. A process in accordance with claim 2, wherein the beginning of the web is wound off by rotating the roller and/or the winding roll onto the second bonding surface without the roller touching the bonding surface.

44. A process in accordance with claim 2, wherein the steps of lifting, placing, cutting, leading and pressing are carried out fully automatically.
